(19) United States
(12) Patent Application Publication
(10) Pub. No.: US 2011/0226830 A1
(43) Pub. Date: Sep. 22, 2011

(54) WINCH TRAY MOUNTING SYSTEM FOR VEHICLES

(75) Inventor: Robert L. West, JR., Seal Beach, CA (US)

(73) Assignee: Westin Automotive Products, Irwindale, CA (US)

(21) Appl. No.: 13/024,656

(22) Filed: Feb. 10, 2011

Related U.S. Application Data
(60) Provisional application No. 61/316,146, filed on Mar. 22, 2010.

(51) Int. Cl. B60R 7/00; B23P 17/04

(52) U.S. Cl. 224/539; 29/428

(57) ABSTRACT

The present invention provides a winch tray mounting system comprising a winch tray and a mounting assembly comprising at least two mounting brackets for attaching the winch tray to frame rails of a vehicle wherein when the winch tray mounting system is attached to the vehicle; (i) each of the at least two mounting brackets is directly attached to both the winch tray and one of the frame rails; (ii) the winch tray is located outside of the vehicle; (iii) the winch tray mounting system and the frame rails form a rigid structural body frame; and (iv) the winch tray mounting system directly translates applied mechanical loads to the frame rails. The present invention also provides a method for attaching the above-described winch tray mounting system to a vehicle comprising: providing the above-described winch tray mounting system, attaching the at least two mounting brackets directly to the winch tray; and attaching the at least two mounting brackets directly to the frame rails.

### CLAIM OF BENEFIT OF FILING DATE

This application claims the benefit of the filing date of U.S. Provisional Application Ser. No. 61/316,146 titled: “WINCH TRAY MOUNTING SYSTEM FOR VEHICLES” filed oh Mar. 22, 2010, this provisional application is incorporated herein by reference for all purposes.

### FIELD OF INVENTION

The present invention relates to vehicle accessory field. More specifically, it relates to a winch tray mounting system for vehicles.

### BACKGROUND OF INVENTION

A winch is a popular accessory for vehicles intended for off-road use. A winch is generally mounted onto a vehicle by attaching itself to a winch tray. When the winch is located “outside of the vehicle” (defined hereinafter as being located either in front of the vehicle's front bumper or behind the vehicle's rear bumper), the winch tray is usually attached to an intermediary apparatus that is then attached to the vehicle. Examples of such intermediary apparatus are front grill guard, front bumper, rear bumper, a hitch receiver, etc. The intermediary apparatus may or may not be attached to the structural frame of the vehicle. The winch tray itself is not attached to the vehicle's structural frame. Accordingly, the mechanical loads applied by operation of a winch attached to the winch tray (hereinafter referred to as “applied mechanical loads”) are generally not translated to the vehicle's structural frame. Without the ability to transfer the applied mechanical loads to the vehicle's structural frame, the conventional winch mounting system is limited in its strength and load capacity.

### SUMMARY OF THE INVENTION

The present invention addresses the above-discussed limitations by providing a winch tray mounting system with robust strength and load capacity. The winch tray mounting system of the present invention includes a winch tray and a mounting assembly comprising at least two mounting brackets for attaching the winch tray to frame rails of a vehicle wherein when the winch tray mounting system is attached to the vehicle: (i) each of the at least two mounting brackets is directly attached to both the winch tray and one of the frame rails; (ii) the winch tray is located outside of the vehicle; (iii) the winch tray mounting system and the frame rails form a rigid structural body frame; and (iv) the winch tray mounting system (e.g., directly) translates applied mechanical loads to the frame rails.

The present invention also provides a method for attaching a winch tray to a vehicle comprising: providing a winch tray mounting system comprising a winch tray and a mounting assembly comprising a first mounting bracket and a second mounting bracket; attaching the first mounting bracket and the second mounting bracket both directly to the winch tray; attaching the first mounting bracket directly to a first frame rail of a vehicle at a first location that allows the winch tray to be located outside of the vehicle; attaching the second mounting bracket directly to a second frame rail of the vehicle at a second location that allows the winch tray to be located outside of the vehicle; wherein (i) the winch tray mounting system, the first frame rail and the second frame rail form a rigid structural body frame; and (ii) the winch tray mounting system (e.g., directly) translates applied mechanical loads to the first frame rail and the second frame rail.

### BRIEF DESCRIPTION OF THE DRAWING

The present invention will be more clearly understood when considering the accompanying drawing of which:

FIG. 1 shows a prospective view of a winch tray mounting system in accordance with the present invention in an assembled configuration;

FIG. 2 shows a prospective exploded view of the winch tray mounting system shown in FIG. 1;

FIG. 3 shows a prospective view of the winch tray shown in FIG. 1;

FIG. 4 shows a prospective view of another embodiment of the winch tray in accordance with the present invention;

FIG. 5 shows a prospective view of the winch tray mounting system shown in FIG. 1 in assembled configuration without attachment to frame rails of a vehicle;

FIG. 6 shows a prospective view of the winch tray mounting system shown in FIG. 5 attached to the frame rails of a vehicle;

FIG. 7 shows a prospective view of an optional face plate and the winch tray shown in FIG. 1;

FIG. 8 shows a prospective view of an optional light bracket for the winch tray mounting system shown in FIG. 1;

FIG. 9 shows a prospective view of the optional light bracket shown in FIG. 8 attached to the winch tray shown in FIG. 1;

FIG. 10 shows a prospective view of an optional decorative bar for the winch tray mounting system shown in FIG. 1;

FIG. 11 shows a prospective view of the optional decorative bar shown in FIG. 10 attached to the winch tray shown in FIG. 1;

FIG. 12 shows a prospective view of a pair of optional tow hooks for the winch tray mounting system shown in FIG. 1;

FIG. 13 shows a prospective view of the pair of optional tow hooks shown in FIG. 12 attached to the winch tray shown in FIG. 1;

FIG. 14 shows a prospective view of an optional receiver and ah optional receiver accessory basket for the winch tray mounting system shown in FIG. 1;

FIG. 15 shows a prospective view of the optional receiver and the optional receiver accessory basket shown in FIG. 14 attached to each other and the optional receiver attached to the winch tray shown in FIG. 1;

FIG. 16 shows a prospective exploded view of an optional grill guard assembly for the winch tray mounting system shown in FIG. 1;

FIG. 17 shows a prospective view of the optional grill guard assembly in an assembled fashion and attached to the winch tray shown in FIG. 1 and a cross member of a vehicle;

FIG. 18 shows a prospective view of another embodiment of a winch tray mounting system in accordance with the present invention.

### DESCRIPTION OF THE PREFERRED EMBODIMENT

I. Definitions

The following terms are intended to have the following general meanings as they are used herein.

1. Applied mechanical loads: the mechanical loads applied by operation of a winch attached to the winch tray

2. Directly attached or attaching directly: a direct attachment or connection; the attached components are either (i) in direct communication or physical contact with each other; or (ii) the attached components are in communication or contact with each other through one or more connecting materials that still allow the winch tray mounting system and the frame rails to form a rigid structural body frame wherein the winch tray mounting system can still translates applied mechanical loads to the frame rails. For example, two components are considered directly attached even if lock washers and/or other similar material separates the two components resulting in no direct physical contact between the two components.

3. Frame rail(s): the structural frame rail(s) of a vehicle.

4. Outside of the vehicle: located either in front of the vehicle's front bumper or behind the vehicle's rear bumper.

II. Description of Exemplary Winch Tray Mounting System

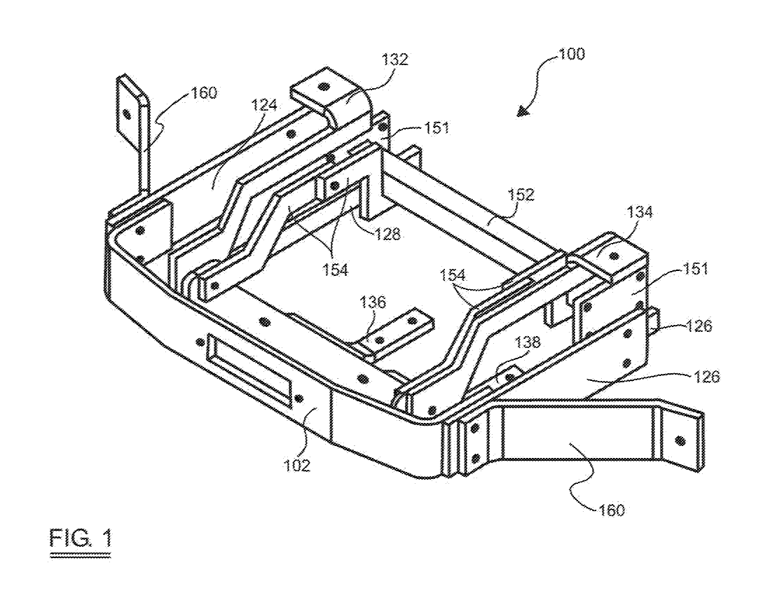

Referring to FIGS. 1-3 showing an embodiment of the winch tray mounting system 100 of the present invention comprising a winch tray 102 and a mounting assembly 104. The winch tray 102 can be in any suitable art-disclosed shape or form for mounting a winch (not shown). The size of the winch tray 102 (including its width 103 and its length 105) is dependent upon size of the winch and/or width of the vehicle. For example, the width 103 of the winch tray may range from about 20 inches to about 65 inches, from about 24 inches to about 60 inches, from about 28 inches to about 50 inches, from about 30 inches to about 40 inches. The length 105 of the winch tray may range from about 5 inches to about 25 inches, from about 6 inches to about 20 inches, and from about 7 inches to about 15 inches, and from about to 8 inches to about 12 inches.

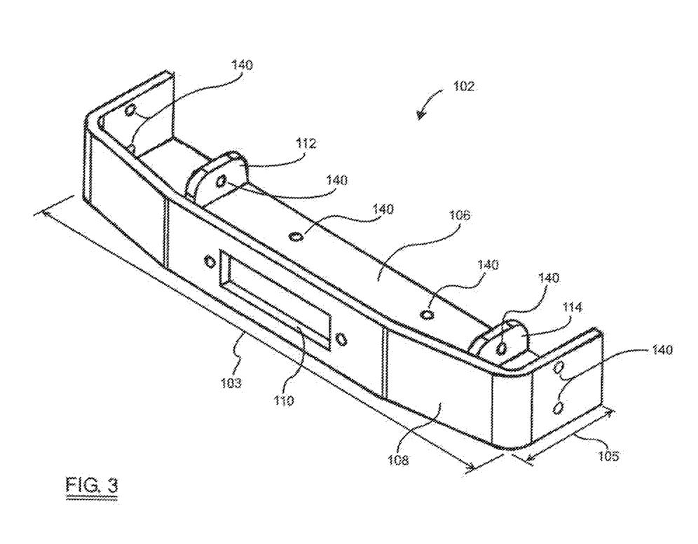

For example and as shown in FIG. 3, the winch tray 102 includes a horizontal member 106 and a vertical member 108 that wraps at least partially around the horizontal member 106. The vertical member 108 may includes a cut-out feature 110 adapted for a winch cable to pass through. Furthermore, the winch tray 102 may include optional additional first vertical feature 112 and second vertical feature 114.

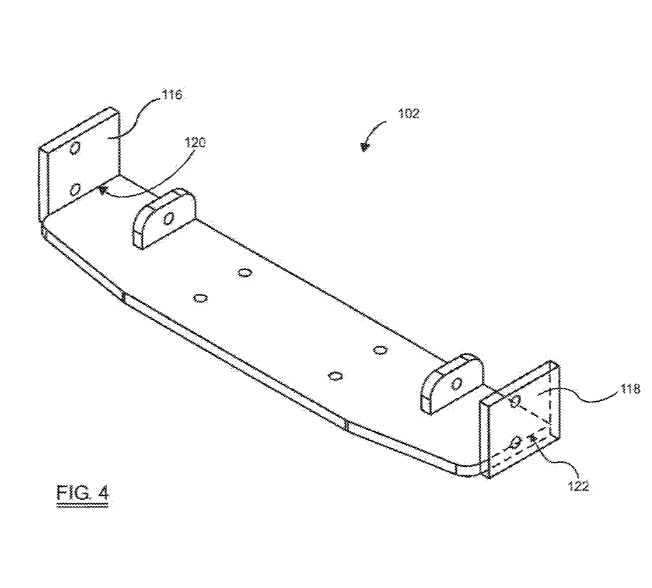

Another example of the winch tray 102 includes the horizontal member 106 and the vertical member 108 wherein the vertical member 108 fully wraps around the horizontal member 106. Alternatively, the vertical member 108 is divided into two separate and spaced portions (a first portion 116 and a second portion 118) that are in communication with a first side 120 and a second side 122 of the horizontal member 106 as shown in FIG. 4.

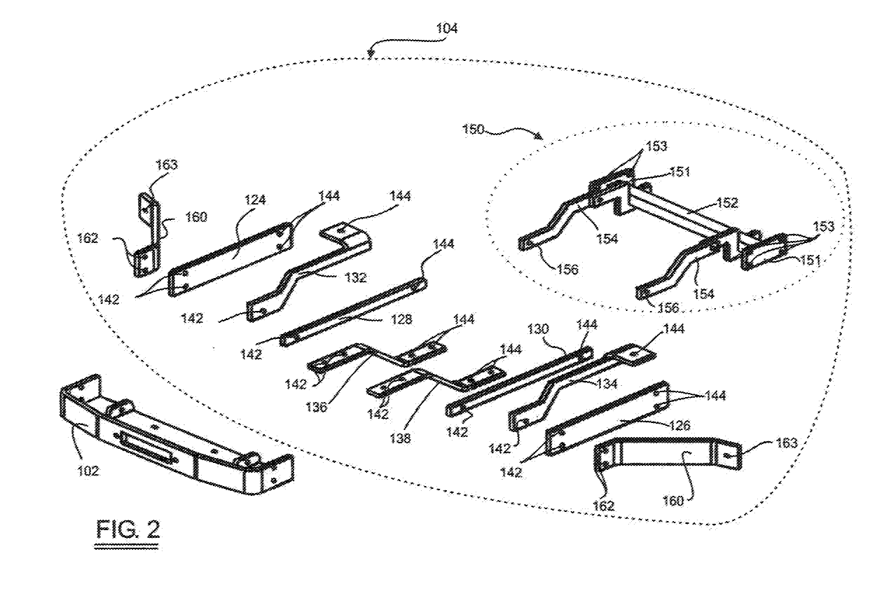

The mounting assembly 104 includes at least two mounting brackets. The at least two mounting brackets can be a combination of the following mounting brackets as shown in FIGS. 1-2: a first outer frame bracket 124, a second outer frame bracket 126, a first inner frame bracket 128, a second inner frame bracket 130, a first top frame bracket 132, a second top frame bracket 134, a first lower frame bracket 136, a second lower frame bracket 138.

Referring to FIGS. 1-3, the horizontal member 106, the vertical member 108, the vertical features (112, 114) all include bracket apertures 140. Each of the at least two mounting brackets (124, 126, 128, 130, 132, 134, 136, and/or 138) has winch tray apertures 142 and frame rail apertures 144. The winch tray 102 is directly attached to the mounting assembly 104 by aligning the bracket apertures 140 with the corresponding winch tray apertures 142 and then secured using suitable art-disclosed fasteners (not shown).

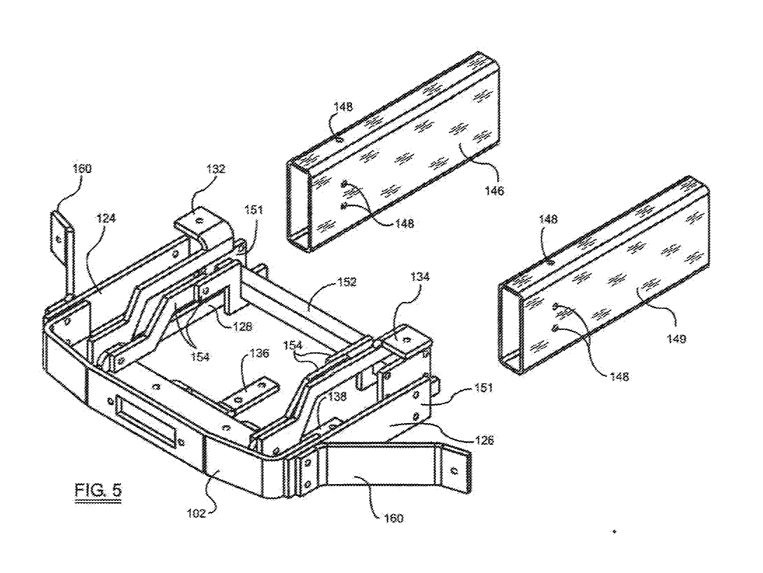

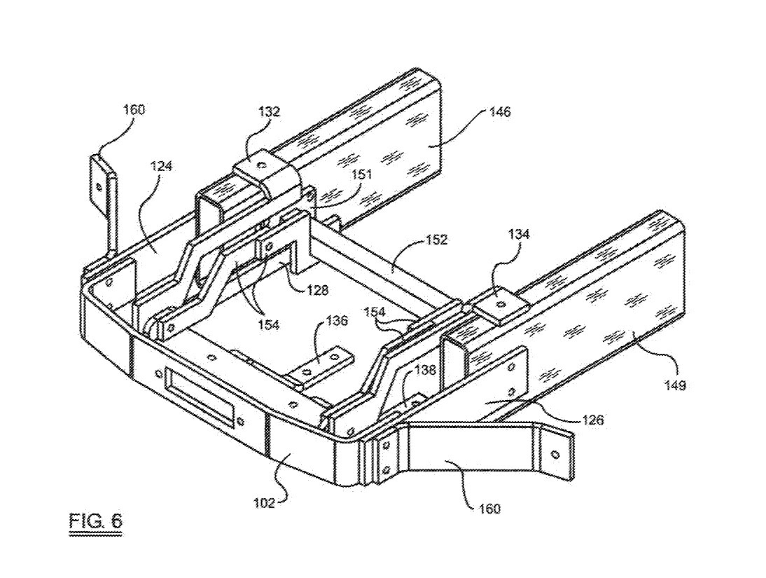

Referring to FIGS. 5-6, at least one of the at least two mounting brackets (124, 126, 128, 130, 132, 134, 136, and/or 138) is directly attached to a first frame rail 146 of a vehicle (not fully shown) by aligning the frame rail apertures 144 with the corresponding receiving apertures 148 drilled into the first frame rail 146 and then secured using suitable art-disclosed fasteners (not shown). Also, at least another one of the at least two mounting brackets (124, 126, 128, 130, 132, 134, 136, and/or 138) is directly attached to a second frame rail 149 of the vehicle (not fully shown) by aligning the frame rail apertures 144 with the corresponding receiving apertures 148 drilled into the second frame rail 149 and then secured using suitable art-disclosed fasteners (not shown).

The receiving apertures 148 may or may not be existing apertures already drilled into the frame rails during vehicle production (146, 149). In one exemplary embodiment, the receiving apertures 148 are existing apertures already drilled into the frame rails during vehicle production. In another exemplary embodiment, the receiving apertures 148 are located in front of each of the frame rails' (146, 149) crumple zone (e.g., between the front bumper and each of the frame rails' crumple zone) so that the vehicle's ability to compress during an accident in order to absorb energy from the impact is not disturbed.

In a first exemplary embodiment, the mounting assembly 104 include the first outer frame bracket 124 and the second outer frame bracket 126. These brackets (124, 126) are directly attached to the winch tray 102 by aligning the bracket apertures 140 with the corresponding winch tray apertures 142 and then secured using suitable art-disclosed fasteners. The first outer frame bracket 124 is directly attached to the first frame rail 146 by aligning the frame rail apertures 144 of the first outer frame bracket 124 with the corresponding receiving apertures 148 drilled into the first frame rail 146 and then secured using suitable art-disclosed fasteners. The second outer frame bracket 126 is directly attached to the second frame rail 149 by aligning the frame rail apertures 144 of the second outer frame bracket 126 with the corresponding receiving apertures 148 drilled into the second frame rail 149 and then secured using suitable art-disclosed fasteners.

In a second exemplary embodiment, the mounting assembly 104 is the same as the above-described first exemplary embodiment but further includes the first lower frame bracket 136 and the second lower frame bracket 138. These brackets (136, 138) are directly attached to the winch tray 102 by aligning the bracket apertures 140 with the corresponding winch tray apertures 142 and then secured using suitable art-disclosed fasteners. The first lower frame bracket 136 is directly attached to the first frame rail 146 by aligning the frame rail apertures 144 of the first lower frame bracket 136 with the corresponding receiving apertures 148 drilled into the first frame rail 146 and then secured using suitable art-disclosed fasteners. The second lower frame bracket 138 is directly attached to the second frame rail 149 by aligning the frame rail apertures 144 of the second lower frame bracket 138 with the corresponding receiving apertures 148 drilled into the second frame rail 149 and then secured using suitable art-disclosed fasteners.

In a third exemplary embodiment, the mounting assembly 104 is the same as any one of the above-described two exemplary embodiments but further includes the first inner frame bracket 128 and the second inner frame bracket 130. These brackets (128, 130) are directly attached to the winch tray 102 by aligning the bracket apertures 140 with the corresponding winch tray apertures 142 and then secured using suitable art-disclosed fasteners. The first inner frame bracket 128 is directly attached to the first frame rail 146 by aligning the frame rail apertures 144 of the first inner frame bracket 128 with the corresponding receiving apertures 148 drilled into the first frame rail 146 and then secured using suitable art-disclosed fasteners. The second inner frame bracket 130 is directly attached to the second frame rail 149 by aligning the frame rail apertures 144 of the second lower frame bracket 138 with the corresponding receiving apertures 148 drilled into the second frame rail 149 and then secured using suitable art-disclosed fasteners.

In a fourth exemplary embodiment, the mounting assembly 104 is the same as any one of the above-described three exemplary embodiments but further includes the first top frame bracket 132 and the second top frame bracket 134. These brackets (132, 134) are directly attached to the winch tray 102 by aligning the bracket apertures 140 with the corresponding winch tray apertures 142 and then secured using suitable art-disclosed fasteners. The first top frame bracket 132 is directly attached to the first frame rail 146 by aligning the frame rail apertures 144 of the first top frame bracket 132 with the corresponding receiving apertures 148 drilled into the first frame rail 146 and then secured using suitable art-disclosed fasteners. The second top frame bracket 134 is directly attached to the second frame rail 149 by aligning the frame rail apertures 144 of the second top frame bracket 134 with the corresponding receiving apertures 148 drilled into the second frame rail 149 and then secured using suitable art-disclosed fasteners.

Referring to FIGS. 1-2, the mounting assembly 104 further optionally includes a cross bar assembly 150. The cross-bar assembly 150 provides additional horizontal structural support to the winch tray mounting system 100. The cross-bar assembly 150 includes a cross-bar horizontal member 152 that is securely attached to two spaced cross-bar mounting brackets 151 and two spaced cross-bar mounting bracket assemblies 154. The cross-bar mounting brackets 151 includes cross-bar frame rail apertures 153. The cross-bar mounting brackets 151 are directly attached to the frame rails (146, 149) by aligning the cross-bar frame rail apertures 153 with the corresponding receiving apertures 148 of the frame rails (146, 149) and then secured using suitable art-disclosed fasteners. Each of the two spaced cross-bar mounting bracket assemblies 154 includes cross bar winch tray apertures 156. The cross-bar assembly 150 is directly attached to the winch tray by aligning the winch tray apertures 156 with the corresponding bracket apertures 140 and then secured using suitable art-disclosed fasteners.

Referring to FIGS. 1-2 and 5-6, the mounting assembly 104 further optionally provides a pair of side strap brackets 160. Each of these side strap brackets 160 includes side strap winch tray apertures 162 and side strap vehicle apertures 163. The side strap brackets 160 are attached to the winch tray 102 by aligning the side strap winch tray apertures 162 with the corresponding bracket apertures 140 and then secured using suitable art-disclosed fasteners. If the outer frame brackets (124, 126) are desired to be attached to the winch tray 102 along with the side strap brackets 160, then the side strap winch tray apertures 162, the corresponding winch tray apertures 142 of the outer frame brackets (124, 126) and the corresponding bracket apertures 140 of the winch tray 102 are all aligned and then secured using suitable aft-disclosed fasteners. In this fashion, each of the outer frame brackets are located between one of the side strap brackets 160 and the winch tray 102 as shown in FIG. 1. The side strap vehicle apertures 163 are used to attach the side strap brackets 160 to other vehicle components such as bumper, etc. (not shown) for additional security and strength.

An example of suitable art-disclosed fasteners for securing; (i) the attachments between the winch tray 102 and the mounting assembly 104, (ii) the attachments between the mounting assembly 104 to the first and second frame rails (146, 149), (iii) the attachment between the cross-bar assembly 150 and the first and second frame rails (146, 149), and/or (vi) the attachment between the cross-bar assembly 150 and the winch tray 102 are bolts and corresponding nuts and lock washers. These bolts, nuts, and lock washers may be constructed of any suitable size (e.g., M10, M12, M14, M16, ⅛″ ¼″, ½″, ⅜″, 9/16, etc.) and material. For example, the bolts, nuts and lock washers are constructed out of tempered steel (e.g., International Organization for Standardization Class 8.8 or 10.9, Society of Automobile Engineers Grade 5 or 8, etc.); or other suitable metal alloy.

The winch tray 102 and the mounting assembly 104 may also be constructed out of any suitable art-disclosed material that provides the desired strength and applied mechanical load capacity. Examples of such material are steel including but are not limited to stainless steel, cold rolled steel, mild steel, high strength steel, tempered steel and other metal alloys. The thickness of each individual component may vary. Examples of suitable thickness are in the range from about ⅛″ to about ½″ and from about 2 mm to about 6 mm.

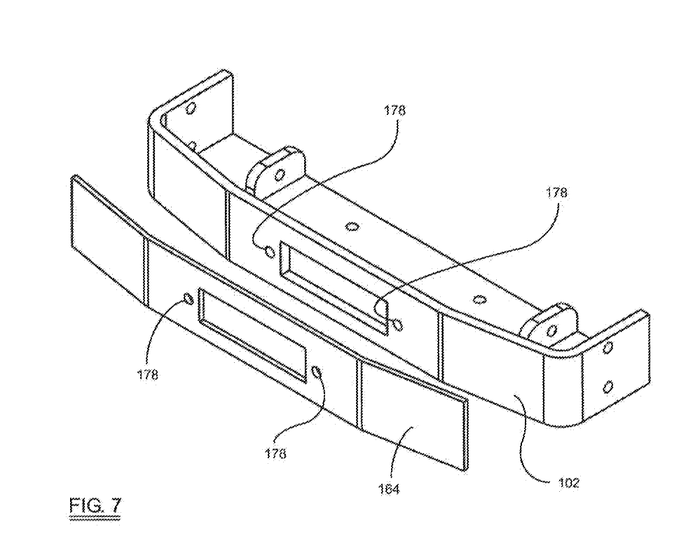

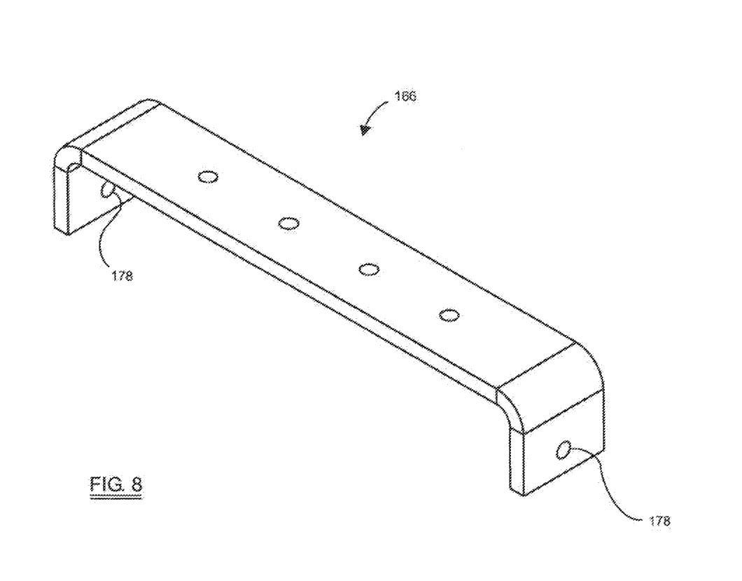

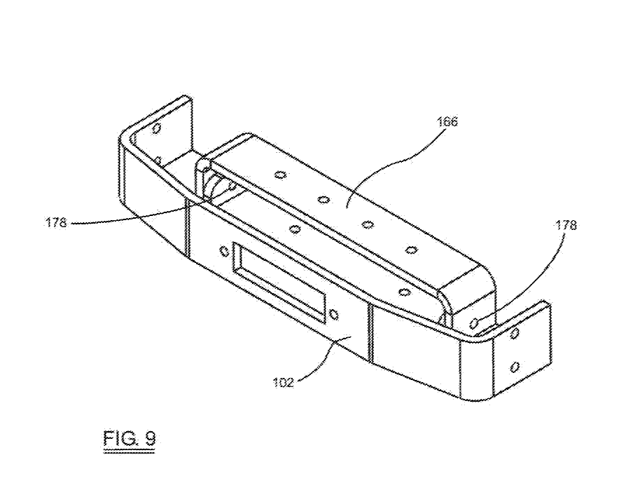

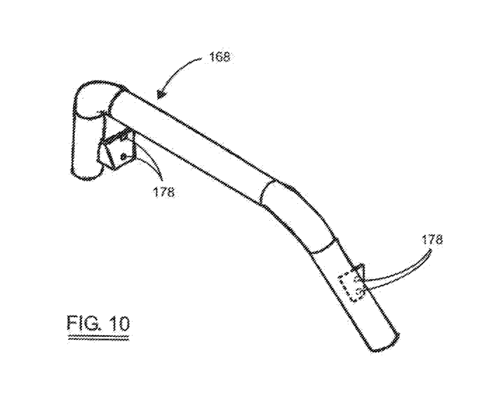

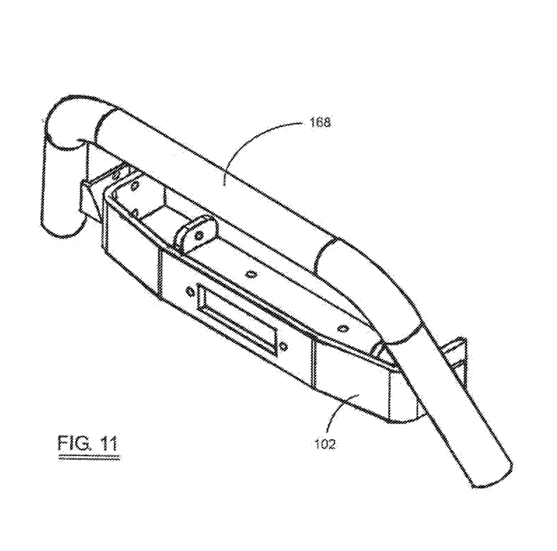

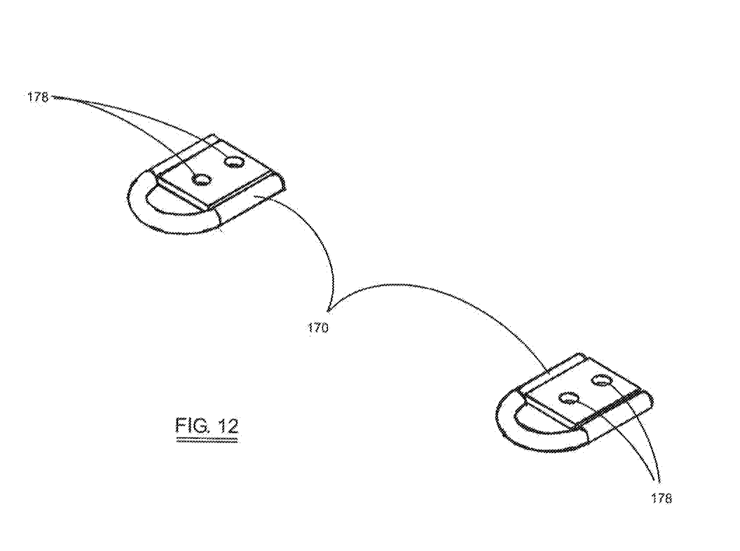

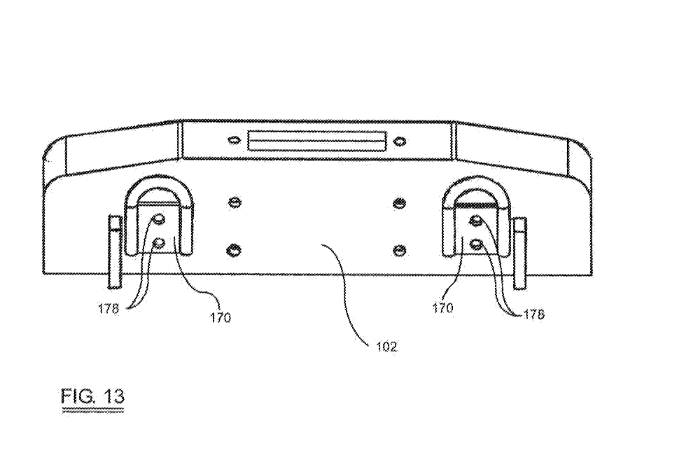

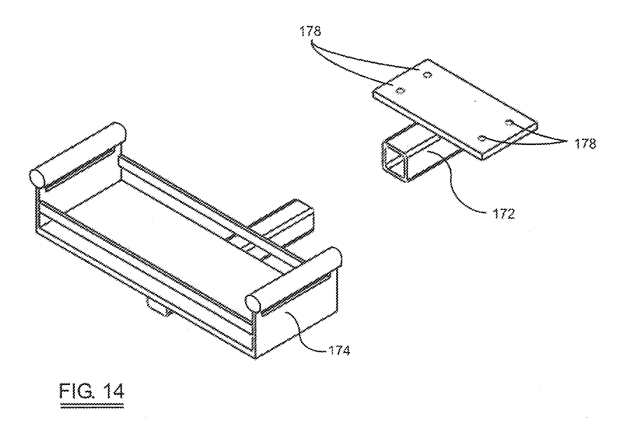

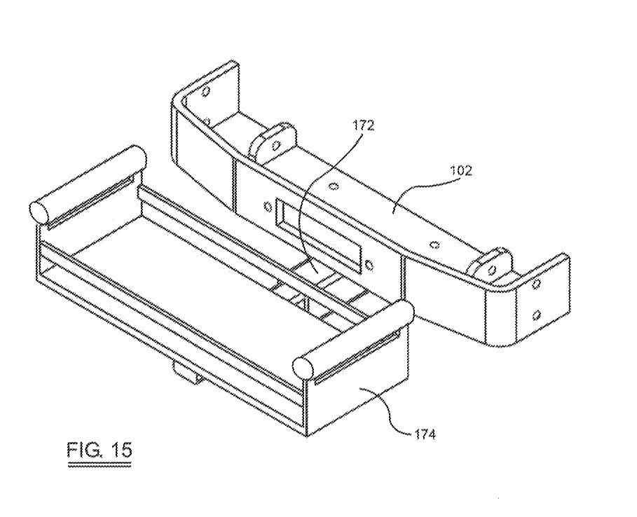

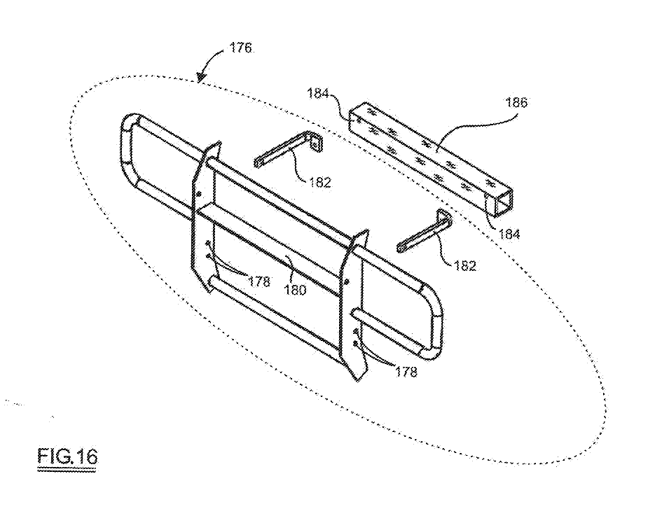

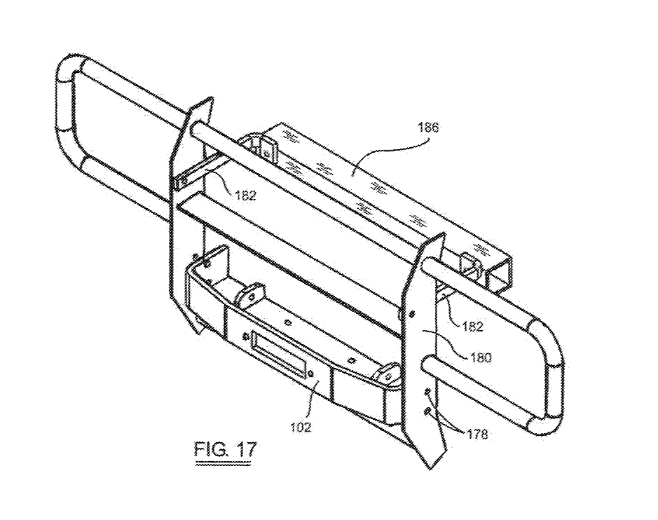

The winch tray mounting system 100 may optionally including the following winch tray accessories: a decorate faceplate 164 as shown in FIG. 7 adapted for attachment to the front of the winch tray 102; a light bracket 166 as shown in FIGS. 8-9; a decorative bar 168 (e.g., a bull bar or a light bar) as shown in FIGS. 10-11, a pair of optional tow hooks 170 as shown in FIGS. 12-13, a receiver 172 as shown in FIGS. 14-15, and a grill guard assembly 176 as shown in FIGS. 16-17. These optional accessories (164, 166, 168, 170, 172 and 176) and the winch tray 102 all include accessory apertures 178. Each of these optional winch tray accessories (164, 166, 168, 170, 172 and 176) are directly attached to the winch tray 102 by aligning the applicable accessory apertures 178 within each of these optional accessories (164, 166, 168, 170, 172 and 176) to the corresponding accessory apertures 178 within the winch tray 102 (as shown in FIGS. 7, 9, 11, 13, 15, and 17) and then secured using suitable art-disclosed fasteners. Examples of suitable art-disclosed fasteners are same as provided above for securing the attachments between the winch tray 102 and the mounting assembly 104. The accessory apertures 178 within the winch tray may include some and/or all of the bracket apertures 140 allowing these apertures to serve dual functions.

Referring to FIGS. 14-15, the receiver 172 is designed to receive any suitable art-disclosed accessory that can be attached to a conventional receiver. For example, the receiver 172 can be a standard 2″ receiver. Examples of suitable art-disclosed accessory are bicycle carrying rack, motorcycle carrying rack, ski and/or snowboard carrying rack, and an accessory basket 174 as shown in FIGS. 14-15.

Referring to FIGS. 16-17, the grill guard assembly 176 includes a grill guard 180 and a pair of grill brackets 182. One end of each of the grill brackets 182 attaches to the grill guard while another end of each of the grill brackets 182 attaches to a vehicle member 186. The vehicle member 186 (e.g., radiator support bar or the like) includes grill guard apertures 184. The grill brackets 182 are directly attached to the vehicle member 186 by aligning the member apertures (not shown) within each of these grill brackets 182 to the corresponding grill guard apertures 184 within the vehicle member 184 (as shown in FIG. 17) and then secured using suitable art-disclosed fasteners. Examples of suitable art-disclosed fasteners are same as provided above for securing the attachments between the winch tray 102 and the mounting assembly 104.

The shape and/or configuration of the winch tray mounting system may vary depending on the vehicle. For example and referring to FIG. 13, another embodiment of the winch tray mounting system 200 is presented comprising the winch tray 202 and the mounting assembly 204. This embodiment 200 has the same components as described above for the winch tray mounting system 100 except that the components of the winch tray mounting system 200 may have different shape and/or configuration as shown in FIG. 13. To show the correlations between the two embodiments (100, 200) of the winch tray mounting system the description of the components of the winch tray mounting system 200 will have in parenthesis the number of the corresponding component of the winch tray mounting system 100.

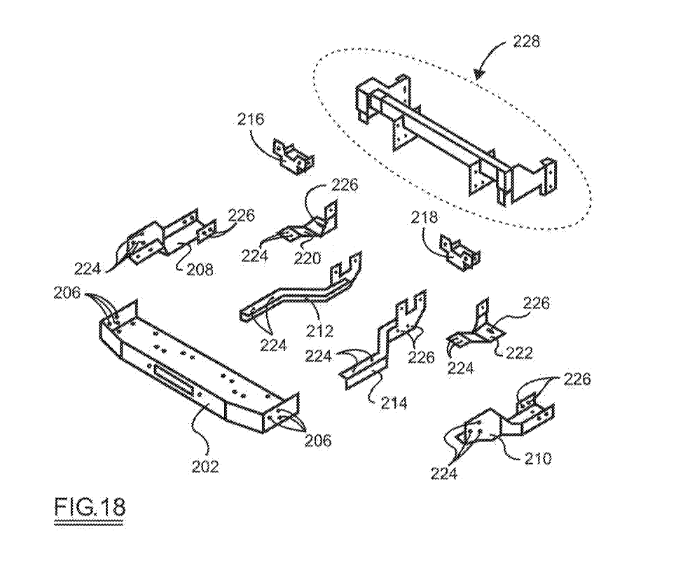

Referring to FIG. 13, the winch tray 202 (102) includes the brackets apertures 206 (140) that attach the winch tray 202 to the mounting assembly 204 (104). The mounting assembly 204 includes at least two of the following: the first outer frame bracket 208 (124), the second outer frame bracket 210 (126), the first inner frame bracket 212 (128), the second inner frame bracket 214 (130), the first top frame bracket 216 (132), the second fop frame bracket 218 (134), the first lower frame bracket 220 (136), the second lower frame bracket 222 (138). All of these frame brackets (208, 210, 212, 214, 216, 218, 220, and 222) have the winch tray apertures 224 (142) and the frame rail apertures 226 (144) for attachment to the winch tray 202 and the frame rails (146, 149). The winch tray apertures and the frame rail apertures for the top frame brackets (216) and 218) are not shown in FIG. 18. The mounting assembly 204 also may include optional items such as the cross-bar assembly 228 (150), the side strap brackets 160 (not shown in FIG. 18), and all of the winch tray winch tray accessories 164, 166, 168, 170, 172 and 176 (not shown in FIG. 18).

When the winch tray mounting system (100 or 200) is attached to the frame rails (146, 149), the winch tray (102 or 202) is located, outside of the vehicle and the winch tray mounting system (100 or 200) and the frame rails (146, 149) form a rigid structural body frame. This rigid structural body frame allows the winch tray mounting system (100 or 200) to directly translate the applied mechanical loads to the frame rails (146, 149) providing robust strength and load capacity, and additional safety.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

What is claimed is:

1. A winch tray mounting, system comprising:
a winch tray; and
a mounting assembly comprising at, least two mounting brackets for directly attaching the winch tray to frame rails of a vehicle; wherein when the winch tray mounting system is directly attached to the vehicle:
(i) each of the at least two mounting brackets is directly attached to both the winch tray and one of the frame rails;
(ii) the winch tray is located outside of the vehicle;
(iii) the winch tray mounting system and the-frame rails form a rigid structural body frame; and
(iv) the winch tray mounting system translates applied mechanical loads to the frame rails.

2. The system of claim 1 wherein width of the winch tray ranges from about 28 inches to about 50 inches.

3. The system of claim 1 wherein length of the winch tray ranges from about 6 inches to about 20 inches.

4. The system of claim 1 wherein the winch tray includes a horizontal member and a vertical member and the vertical member at least partially wraps around the horizontal member.

5. The system of claim 4 wherein the vertical member includes a cut-out feature.

6. The system of claim 1 wherein the winch tray includes a horizontal member and a vertical member and the vertical member is divided into two separate and spaced portions and each of the two separate and spaced portions are in physical communication with the horizontal member.

7. The system of claim 1 wherein the winch tray includes at least one vertical feature.

8. The system of claim 1 wherein:
(i) the winch tray-includes bracket apertures;
(ii) the at least two mounting brackets include, winch tray apertures and frame rail apertures;
(iii) the frame rails include receiving apertures;
(iv) the winch tray is directly attached to the mounting assembly by fasteners attached to (a) the bracket apertures, and (b) the winch tray apertures corresponding to each of the bracket apertures;
(v) the at least two mounting brackets are directly attached to the frame rails by fasteners attached to (a) the frame rail apertures, and (b) the receiving apertures corresponding to each of the frame rail apertures.

9. The system of claim 8 wherein the fasteners include nuts, bolts, and lock washers.

10. The system of claim 1 wherein each of the at least two mounting brackets is selected from a group consisting of: an outer frame bracket, an inner frame bracket, a top frame bracket, and a lower frame bracket.

11. The system of claim 1 wherein the mounting assembly further includes a cross-bar assembly.

12. The system of claim 11 wherein:
(i) the cross-bar assembly includes a cross-bar horizontal member attached to two spaced cross-bar mounting brackets and two spaced cross-bar mounting bracket assemblies;
(ii) the cross-bar mounting brackets includes cross-bar frame rail apertures which are used to directly attach to frame rails of a vehicle with fasteners; and
(iii) the cross-bar mounting brackets; includes cross-bar winch tray apertures which are used to directly attach to the winch tray with fasteners.

13. The system of claim 1 wherein the mounting assembly further includes a pair of side strap brackets attached to both the winch tray and the vehicle.

14. The system of claim 1 wherein the winch tray and the mounting assembly are constructed out of steel.

15. The system of claim 1 wherein the winch tray further includes at least one component selected from the group consisting of a decorative faceplate, a light bracket, and a combination thereof.

16. The system of claim 1 wherein the winch tray further includes at least one component selected from the group consisting of a light bar, a bull bar, and a decorative bar.

17. The system of claim 1 wherein the winch tray further includes a receiver.

18. The system of claim 1 wherein the winch tray further includes a pair of tow hooks.

19. The system of claim 1 wherein:
(i) the winch tray further includes a grill guard assembly comprising a grill guard and a pair of grill brackets;
(ii) the grill brackets are attached to both the grill guard and the vehicle.

20. A method for attaching a winch tray mounting system to a vehicle comprising:
providing a winch tray mounting system comprising a winch tray and amounting assembly comprising a first mounting bracket and a second mounting bracket;
attaching the first mounting bracket and the second mounting bracket both directly to the winch tray;
attaching the first mounting bracket directly to a first frame rail of a vehicle at a first location that allows the winch tray to be located outside of the vehicle;
attaching the second mounting bracket directly to a second frame rail of the vehicle at a second location that allows the winch tray to be located outside of the vehicle; wherein
(i) the winch tray mounting system, the first frame rail and the second frame rail form a rigid structural body frame; and
(ii) the winch tray mounting system directly translates applied mechanical loads to the first frame rail and the second frame rail.
